(19) United States
(12) Patent Application Publication
(10) Pub. No.: US 2011/0197520 A1
(43) Pub. Date: Aug. 18, 2011

(54) LAMINATE SYSTEM

(75) Inventor: Steven S. Preston, Tampa, FL (US)

(73) Assignee: INNOVATIONS & IDEAS, LLC, Tampa, FL (US)

(21) Appl. No.: 12/820,819

(22) Filed: Jun. 22, 2010

Related U.S. Application Data
(63) Continuation-in-part of application No. 12/658,957, filed on Feb. 18, 2010.

(51) Int. Cl. E04D 13/158; B32B 25/00; B32B 15/06; B32B 5/00

(52) U.S. Cl. 52/58; 428/411.1; 428/457; 428/339

(57) ABSTRACT

A laminate for use in building construction adapted to be positioned between a substrate material and an exterior material to avert the passage of water between the exterior material and the substrate material. The laminate includes a rubberized waterproof membrane positioned on a ridged backer, with a peel away sheet entirely covering the membrane.

### CROSS REFERENCE TO RELATED APPLICATION

This application claims priority to currently pending U.S. patent application Ser. No. 12/658,957, entitled “HIDDEN BUTT JOINT FLASHING SYSTEM”, filed on Feb. 18, 2010, the contents of which are hereby incorporated by reference. This application repeats a substantial portion of prior application Ser. No. 12/658,957 and adds and claims additional disclosure not presented in the prior application. Since this application names an inventor or inventors named in the prior application, it constitutes a continuation-in-part of the prior application.

### BACKGROUND OF THE INVENTION

1. Field of the Invention

The present invention relates to a laminate system for use in building construction. More specifically, it relates to a laminate system positioned between a substrate material and an exterior material to avert the passage of water between the exterior material and the substrate material.

2. Description of the Prior Art

Laminates are known in the prior art. While laminate systems fulfill their respective, particular objectives and requirements, they do not describe laminate systems that prevent water from penetrating substrate materials. Therefore, it can be appreciated that there exists a continuing need for a new and improved laminate system that can prevent water from penetrating substrate materials. However, in view of the prior art considered as a whole at the time the present invention was made, it was not obvious to those of ordinary skill in the art how the limitations of the art could be overcome.

### SUMMARY OF INVENTION

The long-standing but heretofore unfulfilled need for an improved laminate system that can prevent water from penetrating substrate materials is now met by a new, useful, and nonobvious invention.

Generally speaking, the laminate system is used during building construction to avert the passage of water between the exterior material and the substrate material. The laminate system includes a rubberized waterproof membrane disposed on a generally ridged backer. The laminate can vary in shape and size depending on the task; for example, stucco stops, L flashings, ridges, stucco/Z flashings, eve drips, metal laths, expansion joints, roll/valleys, siding butt joints, siding lap joints, siding tongue and groove joints, window trims, stucco expansion joints, and the like are all different embodiments of the laminate. The laminate includes a peel away sheet disposed in overlying relation to the rubberized waterproof membrane. The peel away sheet is removed at the time of installation to expose the adhesive properties of the rubberized waterproof membrane.

An embodiment of the laminate system includes a hidden butt joint flashing. The hidden butt joint flashing includes a flashing panel having a self adhering rubberized asphalt waterproofing material secured in overlying relation to a front surface of the flashing panel. A peel away sheet covers the self adhering rubberized asphalt waterproofing material. In an embodiment, the upper edge of the flashing panel is bent forward 135 degrees to form a downward 45 degree angle with the flashing panel. In another embodiment, a top flange project from an upper edge of the flashing panel and is angled between 0-45 degrees. The top flange may include a nail hole.

### BRIEF DESCRIPTION OF THE DRAWINGS

For a fuller understanding of the invention, reference should be made to the following detailed description, taken in connection with the accompanying drawings, in which:

FIG. 1 is a hidden butt joint flashing having an angled top flange;

FIG. 2 is a hidden butt joint flashing having an upper edge bent downward at a 45 degree angle;

FIG. 3 is an embodiment of the laminate for use as a stucco stop;

FIG. 4 is an embodiment of the laminate for use as an L flashing;

FIG. 5 is an embodiment of the laminate for use as a ridge;

FIG. 6 is an embodiment of the laminate for use as Z flashing;

FIG. 7 is an embodiment of the laminate for use as a eve drip;

FIG. 8 is an embodiment of the laminate for use as a metal lath;

FIG. 9 is an embodiment of the laminate for use as an expansion joint; and

FIG. 10 is an embodiment of the laminate stored as a roll.

### DETAILED DESCRIPTION OF THE PREFERRED EMBODIMENT

The laminate includes a combination of two materials laminated together to create a gasket system using a rigid backer and a rubberized water proof membrane. The rigid backer can be made of any metal, plastic or synthetic products and can be bent in any fashion. For example, the backer can be formed for use as a stucco stop, L flashing, ridge, stucco/Z flashing, eve drip, metal lath, expansion joint, roll/valley, siding butt joint, siding lap joint, siding tongue and groove joint, window trim, stucco expansion joint, etc.

In an embodiment, the laminate includes a rubberized waterproof membrane laminated to a shaped aluminum backer. The aluminum acts as a rigid backer for the membrane so it can create a tight seal. The membrane acts as a seal between the aluminum backer and an exterior material to avert the passage of water between the exterior material and a substrate material. The membrane also acts as an adhesive surface.

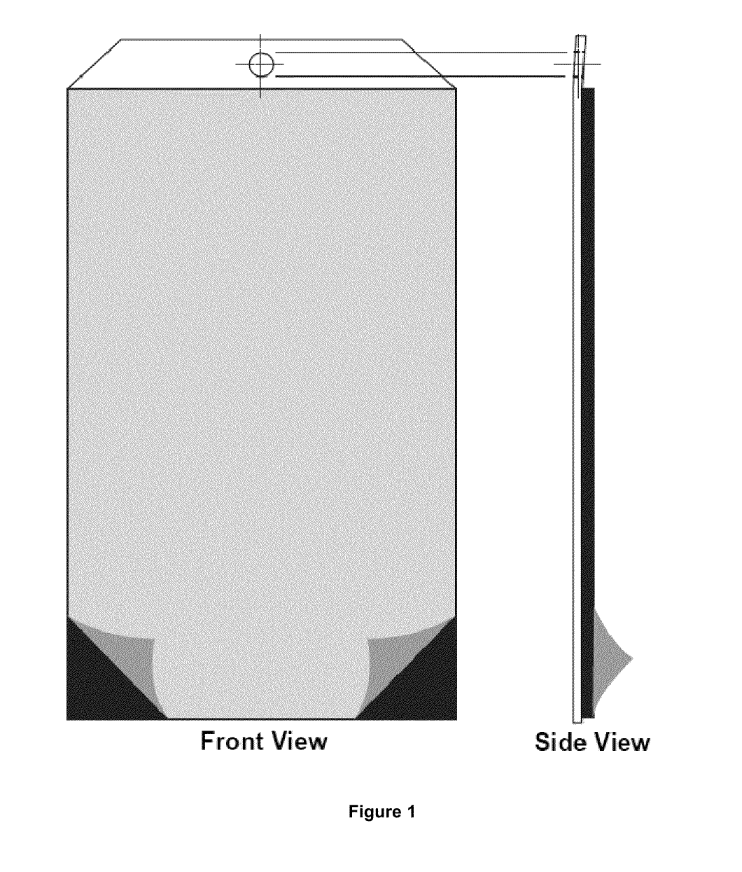

As depicted in FIGS. 1-10, a peel away wax sheet is disposed in overlying relation to the rubberized waterproof membrane and is removed at the time of installation to expose the adhesive properties of the rubberized waterproof membrane.

As depicted in FIG. 1, an embedment of the laminate system includes a hidden butt joint flashing. The flashing is generally rectangular in shape and includes a rigid aluminum backer having an upper edge, a lower edge, a first side edge, a second side edge, a front surface, and a rear surface. A self adhering rubberized asphalt waterproofing material is disposed on the front surface of the ridged backer and is adapted to avert the passage of water between an exterior material and a substrate material. A peel away wax sheet is disposed in overlying relation to the self adhering rubberized asphalt waterproofing material. The flashing includes a top flange that projects up and out at a slight angle from the upper edge of the backer. In use, the top flange is positioned parallel to a wall. A nail hole disposed within the top flange enables the flashing to be nailed in place prior to the installation of siding.

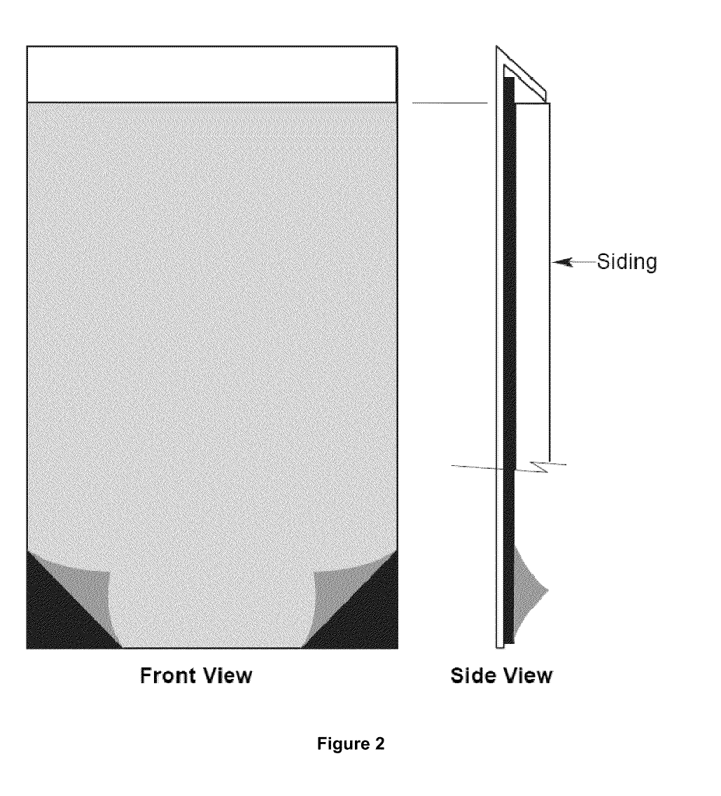

As depicted in FIG. 2, the upper edge of the flashing is bent downward at a 45 degree angle and towards the front surface of the backer. The bent lip helps shed water out of a wall cavity from any leaking joints above the same vertical line. It also creates a cavity underneath the lip to reduce direct contact with the siding, allowing ventilation and reducing possible condensation and corrosion.

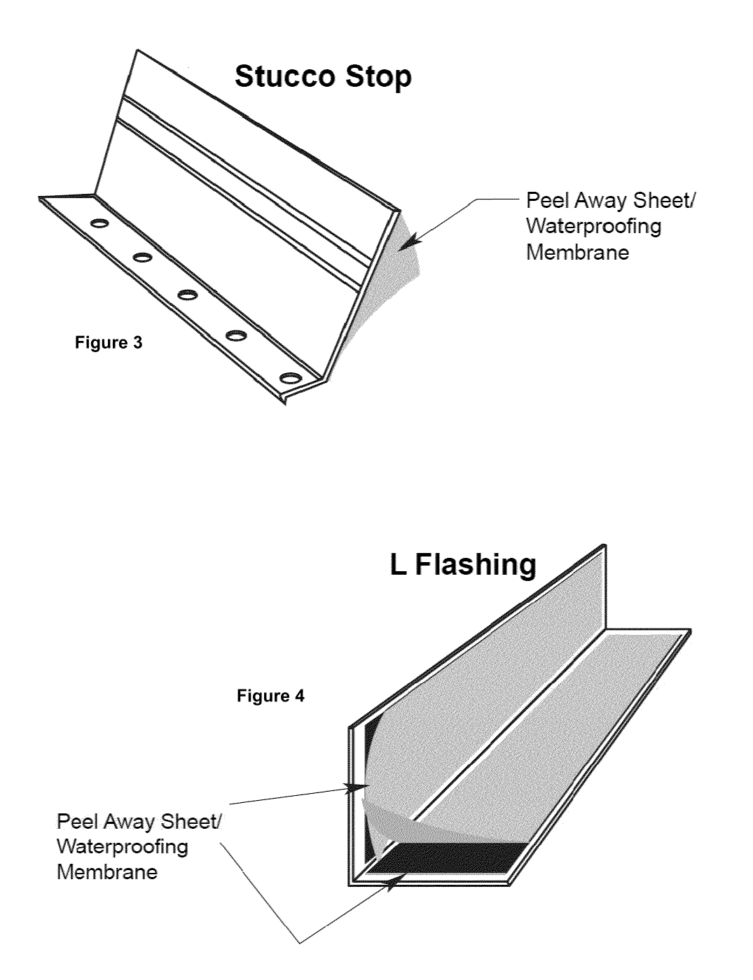

As depicted in FIG. 3, the laminate can be formed for use as a stucco stop.

As depicted in FIG. 4, the laminate can be formed for use as an L flashing.

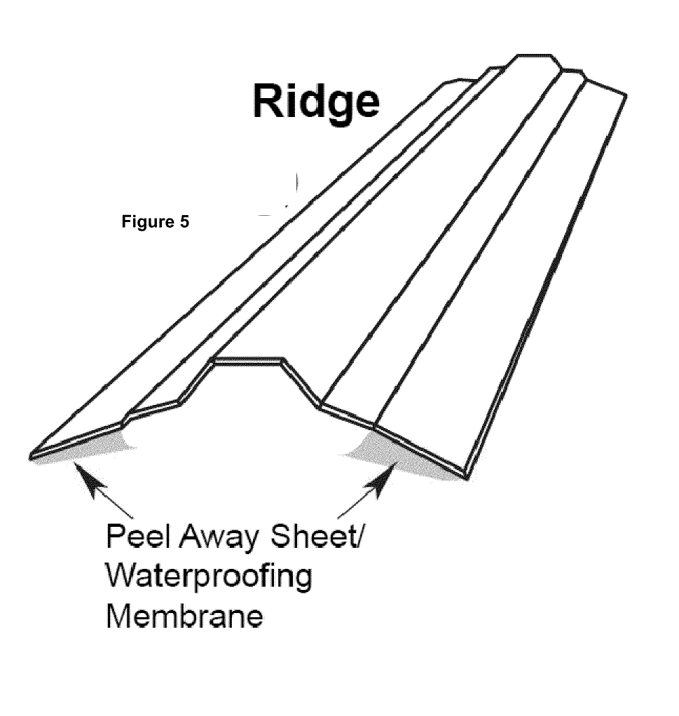

As depicted in FIG. 5, the laminate can be formed for use as a ridge.

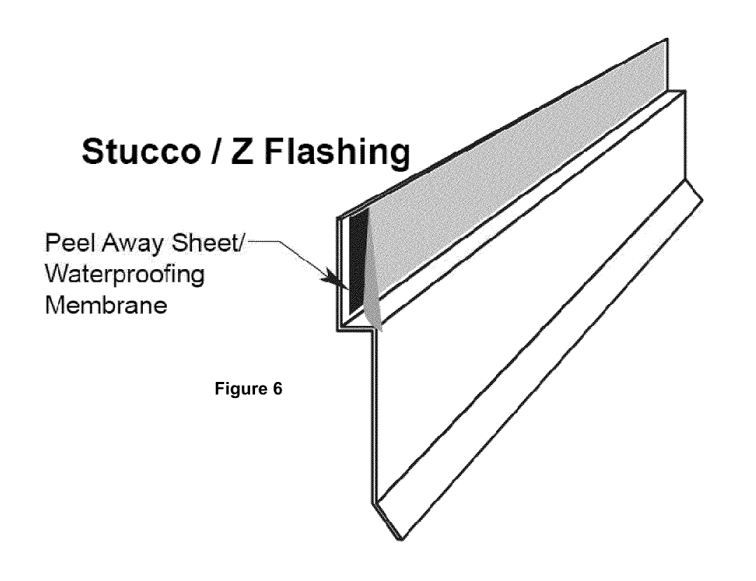

As depicted in FIG. 6, the laminate can be formed for use as Z flashing.

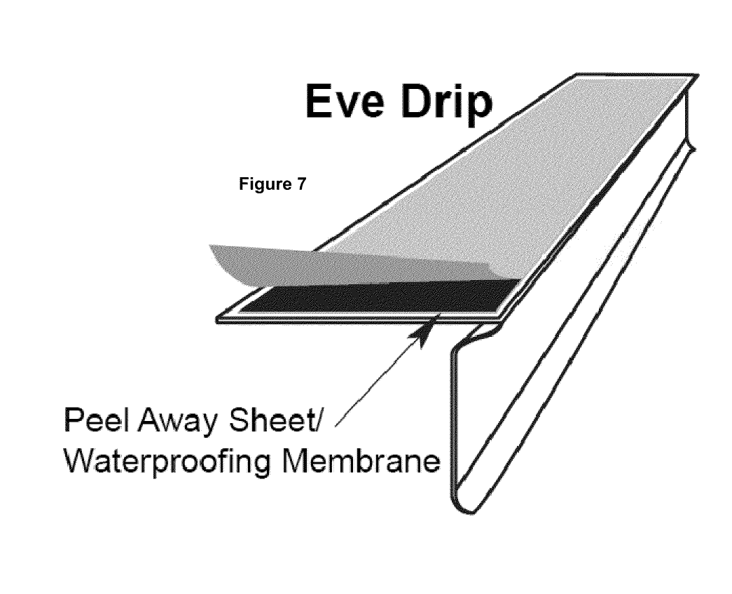

As depicted in FIG. 7, the laminate can be formed for use as an eve drip.

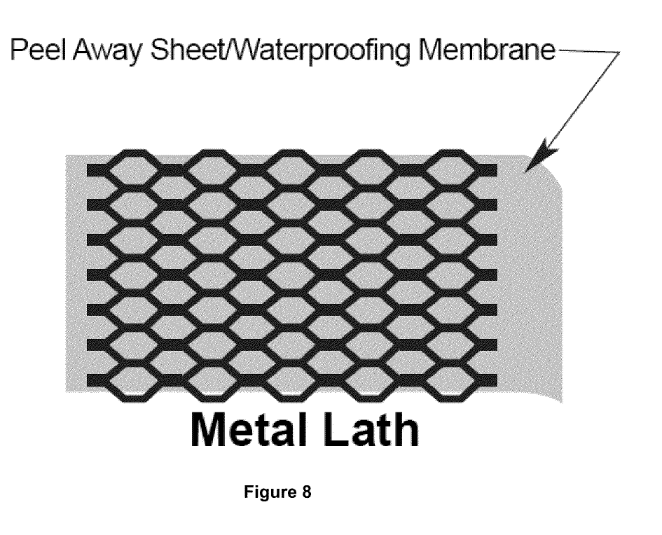

As depicted in FIG. 8, the laminate can be formed for use as a metal lath.

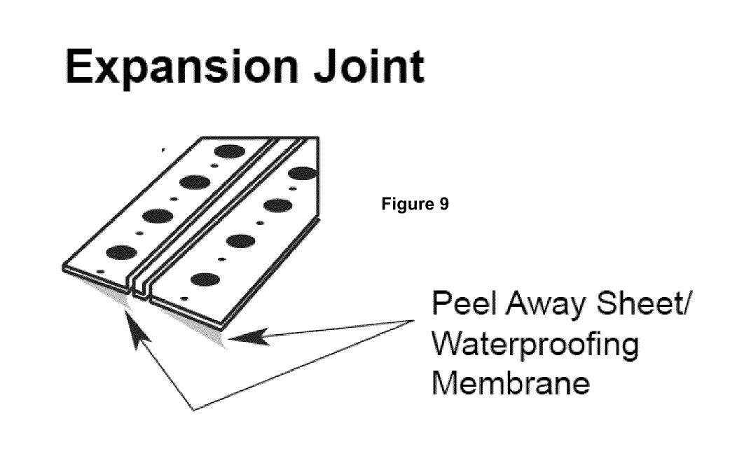

As depicted in FIG. 9, the laminate can be formed for use as an expansion joint.

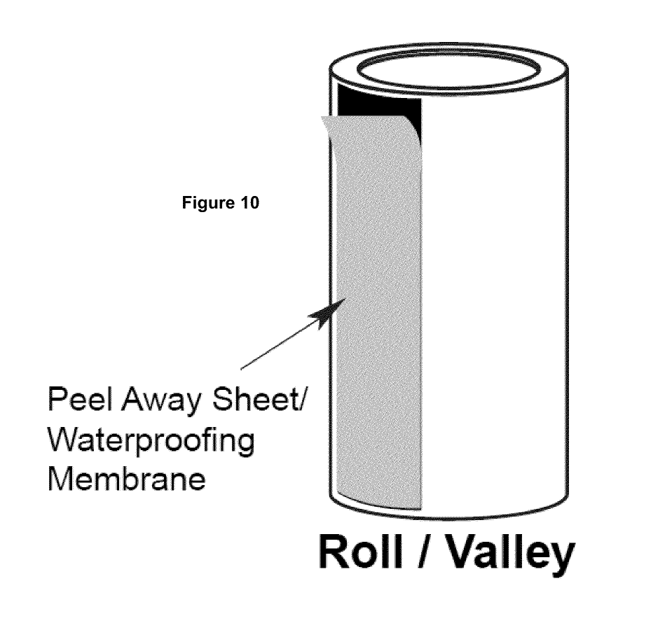

As depicted in FIG. 10, the laminate can be formed stored as a roll/valley.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

What is claimed is:

1. A laminate for use in building construction positioned between a substrate material and an exterior material, comprising:
a generally rigid backer; and
a rubberized waterproof membrane disposed on said ridged backer, said laminate adapted to avert the passage of water between said exterior materials and said substrate material.

2. A laminate as in claim 1, further comprising:
a peel away sheet entirely covering said rubberized waterproof membrane.

3. A laminate as in claim 1, wherein said rubberized waterproof membrane acts as an adhesive.

4. A laminate as in claim 1, wherein said rigid backer is fabricated of a construction material chosen from the class of construction materials including metal, plastic, and synthetic products.

5. A laminate as in claim 1, wherein said laminate, prior to use, is in a form chosen from the class of forms including flat sheet form and roll form.

6. A laminate as in claim 1, wherein said laminate, prior to use, is bent to a shape for a particular use.

7. A laminate as in claim 1, wherein said laminate is formed for use in a plurality of waterproofing application including a stucco stop, L flashing, ridge, Z flashing, eve drip, metal lath, expansion joint, roll, siding butt joint, siding lap joint, siding tongue and groove joint, window trim, stucco expansion joint, or any exterior building envoplope componant.

8. A laminate as in claim 1, wherein said rubberized waterproof membrane has a thickness of between 20 and 70 mils thick.

9. A laminate as in claim 1, wherein said rubberized waterproof membrane is disposed on both sides of said ridged backer.

10. A hidden butt joint flashing, comprising:
a flashing panel having an upper edge, a lower edge, a first side edge, a second side edge, a front surface, and a rear surface; and
a rubberized waterproof membrane material secured to said front surface of said flashing panel in overlying relation.

11. A hidden butt joint flashing as in claim 10, wherein said upper edge is bent forward 135 degrees to form a 45 degree angle with said flashing panel.

12. A hidden butt joint flashing as in claim 10, further comprising:
a peel away sheet entirely covering said rubberized waterproof membrane material.

13. A hidden butt joint flashing as in claim 10, further comprising:
a top flange projecting from said upper edge of said flashing panel, said flange being angled between 0-45 degrees.

14. A hidden butt joint flashing as in claim 13, further comprising:
a nail hole disposed within said top flange.

15. A hidden butt joint flashing as in claim 10, wherein said rubberized waterproof membrane acts as an adhesive.
